(19) United States
(12) Patent Application Publication
(10) Pub. No.: US 2011/0127113 A1
(43) Pub. Date: Jun. 2, 2011

(54) ELEVATING DEVICE FOR A STAIRCASE

(76) Inventor: Albert H. Vanderburgh, Oakville (CA)

(21) Appl. No.: 13/001,656

(22) PCT Filed: Mar. 29, 2010
(86) PCT No.: PCT/CA2010/000421

§ 371 Date: Dec. 28, 2010

(30) Foreign Application Priority Data
Apr. 3, 2009 (CA) 2661101

(51) Int. Cl. B66B 9/00; B66B 9/04

(52) U.S. Cl. 187/200

(57) ABSTRACT

An elevating system is provided for installation on a staircase, comprising a plurality of lifting elements capable of vertical expansion and contraction between lowered and elevated positions to sequentially elevate or lower a user. Each lifting element comprises a platform, inflatable bladders to selectively elevate or lower the platform, a guide to prevent lateral movement of said platform, a sensor responsive to the presence of an individual on said platform, and valves to selectively inflate or deflate said bladders. The platforms are sequentially elevated or depressed to permit the user to travel up or down said staircase by stepping horizontally from one lifting element to a next in line lifting element.

### FIELD OF THE INVENTION

The invention relates to mechanical systems to assist an individual in ascending or descending a staircase, and in particular a system which can be installed on an existing staircase to convert the staircase to a semi-automated mode of operation, or built-in as a new structure as a component of a staircase.

### BACKGROUND OF THE INVENTION

Staircases often present an obstacle to the elderly or infirm. Such individuals may be capable of walking along a level surface, but experience difficulty when required to step up or down a staircase. While public buildings are usually provided with an elevator or escalator, this is usually not the case in a residential setting or the setting of a smaller institution. It is often impractical or very costly to retrofit an existing home or building with an elevator or escalator. There is therefore a need for systems which permit an elderly or infirm person to reach a different level within a building. Systems have been previously proposed that permit an individual to travel between floors without the effort of climbing a staircase. These include a chair lift which operates on a rail mounted on or adjacent to a staircase. However, it is not always possible or convenient to install this type of system, and such systems typically involve a more or less permanent installation, and tend to restrict or clutter the staircase.

Stair lift systems have also been proposed which provide a series of lifting elements which may be installed on the treads of a staircase, to sequentially elevate a user, one step at a time, up or down the staircase. For example, U.S. Pat. No. 7,131,522 to Sircovich discloses a system of this type. Similar systems have also been disclosed in U.S. Pat. No. 2,341,463 and French Patent No. 2.127.279. Systems of this type within the prior art have generally involved complex mechanical mechanisms for raising and lowering the tread platforms. Such systems tend to be relatively bulky, and require a relatively extensive retrofit of the staircase in order to install this type of system. As well, in many such systems the user must step a full step onto the lowermost platform, thereby lessening the usefulness of such systems for infirm users.

### SUMMARY OF THE INVENTION

In one aspect, the invention relates to a system and method for assisting an individual to ascend or descend stairs. The system is referred to herein as being “semi-automatic” in operation, in that it requires the user to step forwardly while using the system, albeit only in a horizontal direction while essentially eliminating the up or down stepping motion for the user. In contrast, a fully automatic system such as a conventional escalator permits the user to remain standing and essentially immobile while being carried up or down. According to another aspect, the present system can be installed in a temporary or permanent fashion on an existing staircase, to convert the staircase into a semi-automatic mode of operation.

According to one aspect, the invention relates to an elevating system for installation on a staircase, comprising a plurality of lifting elements configured to each cover at least a portion of a tread of the staircase. Preferably, the elements cover essentially the entire tread, thereby rendering the system effective for users and visually less obtrusive. The lifting elements are capable of vertical movement between a lowered position and an elevated position so as to sequentially elevate or lower an individual user of the staircase. Each lifting element comprises a platform to support the user, an inflatable bladder configured for positioning between said staircase tread and said platform to selectively elevate said platform when inflated and lower said platform when deflated, a guide member to restrict lateral movement of said platform and confine movement of the platform to essentially vertical movement, a sensor responsive to the presence of an individual on said platform, and valve means to selectively inflate or deflate said bladders. The system further comprises an air supply in communication with the lifting elements to selectively and sequentially inflate the bladders thereof. A user interface or user command switch may be provided, preferably at both the top and bottom of the staircase. Alternatively or in addition, the system may be configured for automatic operation that does not necessarily require a user interface or command switch at the top and bottom of the stairs. The system is controlled by a controller which is in communication with said sensors, valve means, user command switches and air supply. The controller operates said system to selectively and sequentially elevate or depress the platforms to permit the user to travel up or down said staircase by stepping horizontally from one of said lifting elements to a next in line of said lifting elements.

The guide may comprise pantograph or scissors assemblies engaged to said platform. Preferably, the lifting elements also include a base plate opposed to said platform. The bladder is positioned between said base plate and said platform, with said guide means being mounted to said base plate to confine said platform to vertical movement directly above said base plate.

The system comprises means to control discharge and intake of air to selectively inflate or deflate the bladders. As will be seen by one skilled the art, a wide range of such means may be provided, not limited to the specific means described herein. For example, one or more valves may be provided in communication with the air supply and bladders for this purpose. Alternatively, valve means may be used for this purpose that serve essentially the function of a valve, by different means known to the art. Other means are within the contemplation, skill and knowledge of the skilled person to provide these functions. Preferably, a single air supply is connected by tubing to all of said bladders. A trunk tube extends from the air supply with individual branch tubes leading to valves for each bladder, to deliver air to the individual bladders. The valves are controlled by the controller according to the operating sequences described herein. Preferably, the valves are attached directly to the bladders, although other locations for the valves are possible.

The controller can be configured to delay the elevation or lowering of said platforms for a predetermined duration following sensing of said user stepping on or off of said platform, and/or to provide a measured acceleration or deceleration of the lifting elements to avoid abrupt starts and stops.

According to another aspect, the system is configured to detect the presence of a user properly standing upon the lifting element before the lifting element is actuated. This may be accomplished by providing dual spaced apart pressure sensors on the platform, positioned to approximate the foot positions of a user standing on a central part of the platform. The controller actuates the lifting elements to elevate or lower when both sensors detect the presence of a user, indicating that the user is properly standing upon the platform. Alternatively, the sensor and/or controller may be configured to respond to a minimum weight bearing on said platform, to discriminate against pets, infants and the like who may use the staircase.

According to another aspect, the invention relates to a method of retro-fitting a staircase to automatically elevate or lower a series of tread platforms, comprising the steps of providing a system as defined herein, positioning a first of said lifting elements on a floor adjacent to a lowermost riser of said staircase, positioning next in line of said lifting elements on the treads of said staircase, and positioning said air supply, controller and optionally said user interface adjacent or in proximity to said staircase for operation by a user.

The invention further relates to a method of assisting a person to climb or descend a staircase using the system as described herein, in the manner described herein.

The present invention is believed to provide various advantages over prior art systems, including the ability to provide a lifting element that has a low profile, with a user platform that can essentially cover the entire tread of each stair. As well, the system can operate quietly and rapidly using a relatively low pressure, low voltage air supply, thereby providing a system which is relatively unobtrusive when not in use, quiet and safe.

Having generally described the invention, the invention will be further described by reference to a detailed but non-limiting embodiment thereof.

### BRIEF DESCRIPTION OF THE DRAWINGS

FIG. 1 is a perspective view of an elevating device according to the present invention, installed on an existing staircase.

FIGS. 2a through 2c are side elevational views of a lifting element portion of the device, wherein FIG. 2a shows the element in a collapsed position, FIG. 2b shows the element in a partially elevated position, and FIG. 2c shows the element in a fully elevated position. The pleated skirt has been removed to show internal components.

FIG. 2d is a more detailed side elevational view as in FIG. 2c of the lifting element in a fully elevated position.

FIG. 2 e is a front elevational view of a portion of the guide assembly, viewed from line e-e of FIG. 2d.

FIG. 2f is a plan view of a portion of the guide assembly, in the collapsed position, viewed from line f-f of FIG. 2a.

FIG. 3 is a front elevational view of the lifting element, with the pleated skirt in place.

FIG. 4 is a schematic view of the device, showing multiple tread lifts, control unit and the associated air supply and hose connection network.

FIG. 5 is a side view of the bladder portion of the device, in the uninflated position.

FIG. 6 is a side view of the bladder portion, in the inflated position.

FIG. 7 is a sectional view along line 7-7 in FIG. 6.

FIGS. 8a to 8d are a series of side elevational views of the device, showing its sequence of operation.

FIG. 9 is a flow chart showing operation of the system in the “up” mode to convey a user up the staircase.

FIG. 10 is a flow chart showing operation of the system in the “down” mode to convey a user down the staircase.

### DETAILED DESCRIPTION

Turning to the figures, an embodiment of the elevating device according to the invention is shown installed on a short flight of stairs 14, such as the stairs connecting two levels of a split-level dwelling, or other relatively small change in elevation between levels. It will be seen that the device may be readily adapted and configured for installation on essentially any length, layout and configuration of staircase or flight of stairs, whether within a dwelling or any other structure, or outdoors, and is not limited in scope in this regard.

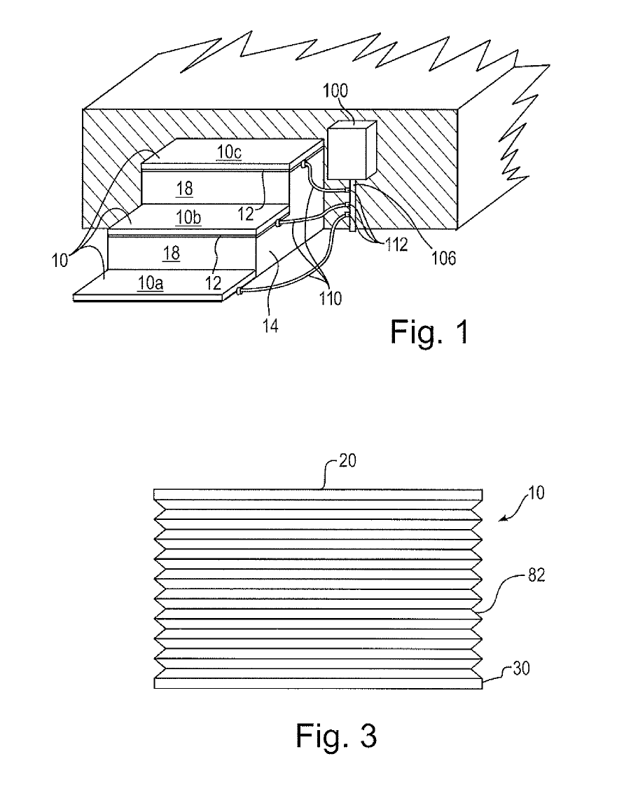

Referring first to FIG. 1, the device comprises a plurality of individual lifting elements 10 which are configured to be each placed on and essentially cover treads 12 of staircase 14. Lifting elements 10 may be provided in one or more standard sizes which may be fitted to a variety of stair configurations, or alternatively customized in a range of configurations to cover both standard and non-standard stair configurations.

First lifting element 10a is placed on the floor of the dwelling at the base of the staircase 14. Optionally, this element may be installed directly on the sub-floor, such that element 10a is generally flush with the floor. Next-in-line lifting element 10b rests upon the first tread of the staircase, and subsequent lifting elements 10c and so forth rest upon subsequent treads. Lifting elements 10 may be simply overlain on the floor and treads 12, or for more security, may be fastened to the treads by various fastening means, as will be described below.

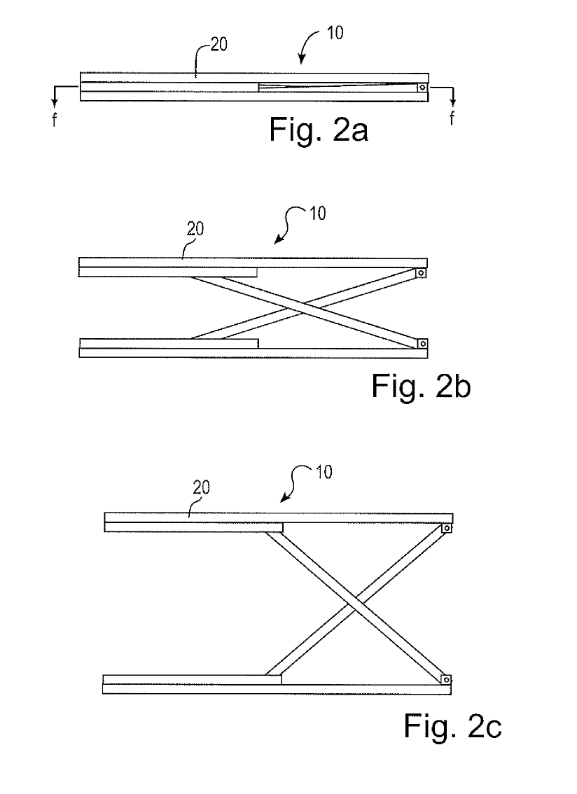

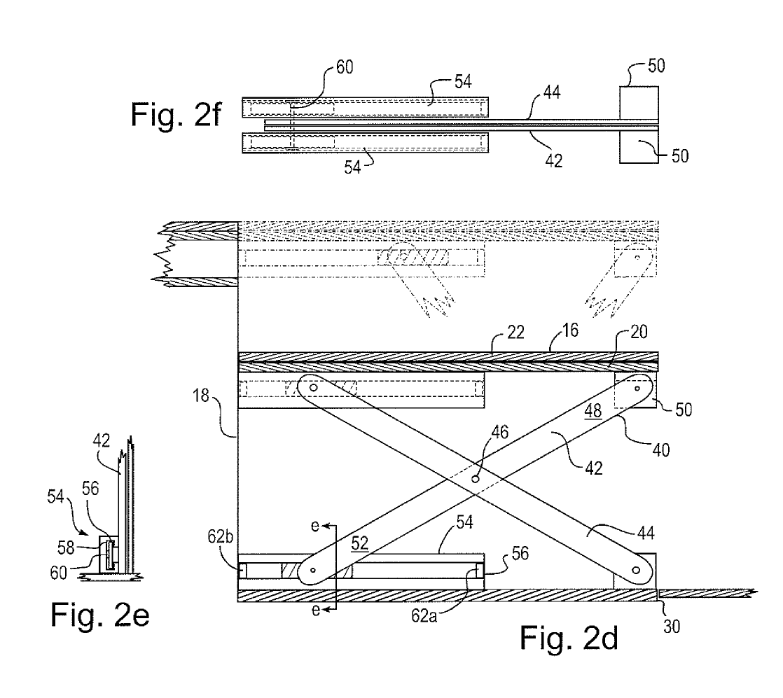

Each lifting element 10 may be disposed in a fully lowered position, seen in FIG. 2a, in which the lifting element has a relatively low profile which in a non-limiting example is about 15/16 inches (2.4 cm) in height, excluding the carpet or other covering on the platform, and an elevated position, seen in FIGS. 2c and 2d. FIG. 2b shows element 10 in a partially raised position, as would exist when element 10 is in transition between the fully lowered and raised positions of FIGS. 2a and 2c. In the fully elevated position, lifting element 10 provides an upper surface 16 which is essentially flush with the upper surface of the next-in-line lifting element, when this next-in-line element is in the lowered position. When thus configured, a user may step from one lifting element to the next-in-line lifting element without having to step up or down. In the example shown in FIG. 1, the staircase comprises two treads 12 and three risers 18. Three lifting elements 10 are provided, the first 10a being on the floor adjacent to the first riser, and the next two in line 10b and 10c being on the treads 12.

As will be discussed in more detail below, the maximal heights of the lifting elements 10 vary depending on their position on the staircase and the staircase riser height.

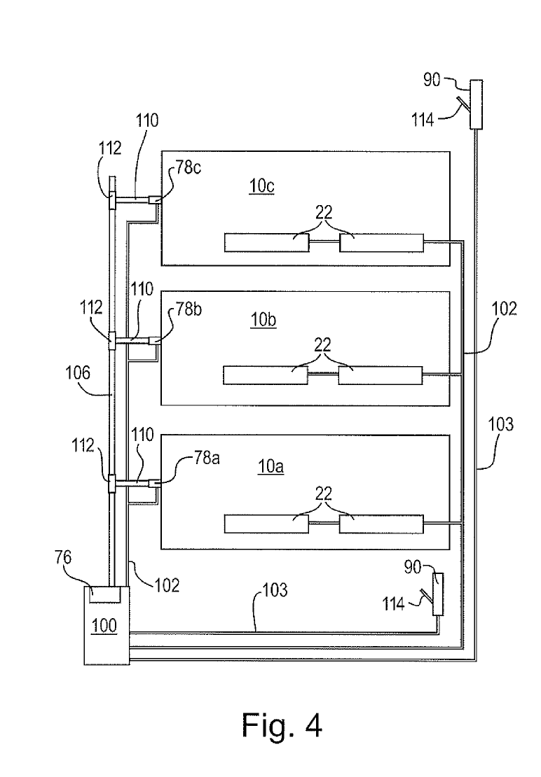

As seen more particularly in FIG. 2d, lifting element 10 comprises an upper platform 20, consisting of a rigid plate which provides the stepping surface 16 for the user. The upper surface of the plate may be exposed and comprise a material such as metal or wood, on which the user steps. Alternatively, carpeting or other surfacing (not shown) may cover the plate, both for appearance and to provide a slip-resistant surface. A sensor 22 is provided to detect the presence of a user on the platform is associated with platform 20. Sensor 22 may comprise any convenient means to detect whether a person is standing on platform 20. In the present example, two pressure sensors 22 are positioned on or under plate 20 in a spaced apart configuration to detect when the user has placed both feet on the platform, as seen more particularly in FIG. 4. The configuration of sensors 22 may be selected to provide a suitable area of coverage, so as to ensure that a person stepping on the element 10 within a suitable range of locations will bear on the sensors.

In one version, pressure sensor 22 comprises one or more pads mounted on the upper surface 16 of platform 20, over which is laid a carpet or other covering.

The base of lifting element 10 optionally comprises a base plate 30, comprising a rigid flat plate configured to substantially cover the existing tread of the staircase. Base plate 30 and platform 20 are preferably essentially identical in configuration and are directly opposed to each other such that when collapsed, platform 20 essentially fully overlies base plate 30. Base plate 30 may be provided with a non-slip surface intended to be directly placed on the staircase tread without further attachment. This is suitable, for example, if the existing tread is covered with a carpet or a non-slip surface. However, it is preferable to provide an additional attachment means (not shown) to securely fasten the base plate to the existing tread. It is contemplated that any suitable attachment means may be employed, for example threaded screws or bolts, a nailed attachment, or the like. Alternatively or in addition, base plate 30 may be attached to staircase riser 18, for example with an upwardly projecting tab configured to abut a portion of the riser for attachment thereto. It will be evident that it is of importance that the lifting element is prevented from slipping off the staircase tread during use.

Platform 20 is mounted to a guide assembly 40 which prevents lateral movement of platform 20, thereby ensuring that it is restricted in its movement to vertical travel. Guide 40 comprises at least two, and preferably four, scissors or pantograph assemblies, based on the Scott-Russell straight line motion action. Each guide assembly comprises two arms 42 and 44, arranged in an X, with a pivot joint 46 where the arms intersect. The guide assembly 40 permits platform 20 to be elevated or lowered, while restricting its lateral movement. In one version, two guide assemblies 40 are provided at adjacent sides of platform 20. In another version, four guide assemblies 40 are provided, adjacent to all four sides of platform 20. The latter version is preferred, in that it provides the most stability to the system.

The first arm 42 of the guide assembly 40 is mounted at its upper end 48 to the platform 20 with a non-sliding pivot mount 50 which protrudes downwardly from the upper platform. Pivot mount 50 permits the arm 42 to rotate freely relative to the platform. The opposed lower end 52 of the first arm 42 is slideably engaged to a sliding mount 54 protruding upwardly from the base plate 30, as shown in FIGS. 2 and 3. As seen in more detail in FIG. 2e, the sliding mount 54 comprises an elongate track 56 having a channel 58 recessed horizontally into a sidewall thereof. A rotatable wheel 60 is mounted to the lower end of the arm 42, which is received within the channel 58 for travel within channel 58, lengthwise along the mount. Travel of wheels 60 within channel 58 is limited by at one end by a stop 62(a) which is adjustable in its location along channel 58. At the opposed end, travel of wheels 60 is limited by a non-adjustable stop 62 (b). Adjusting the location of stop 62(a) serves to vary the maximal elevation of platform 20.

The second arm 44 of the guide assembly 40 is similar to first arm 42, and is pivotally mounted at its lower end 52 to the base plate 40, and slideably mounted to the platform at its upper end 48. The respective pivot and slideable mounts 50 and 54 are as described above, but protruding from the base plate and platform respectively. In this fashion, guide assembly 40 is capable of a scissors-like movement, wherein the respective ends converge in the extended position and diverge when the platform is lowered in its collapsed position.

It will be further seen that the guide arms 42 and 44 are relatively shallow in height such that when in the collapsed position, the guide assembly 40 folds into a relatively low profile. In order to minimize the profile of the lifting assembly, the respective guide arm mounts 50 and 54 are configured in a staggered relationship, such that they are located in positions that are offset from each other, as seen particularly in FIG. 2f. As seen in FIG. 2d, the respective mounts projecting from the platform and base plate are located on opposing sides of the guide arms, such that when collapsed, these members are positioned alongside each other, as shown in FIG. 2f.

In another version, not shown, base plate 40 is omitted and the mounts 50 and 54 for the lower ends of the arms of the pantograph assemblies can be mounted directly to the existing stair tread. This configuration permits a slightly lower profile of the lifting element 10, since the base plate is eliminated.

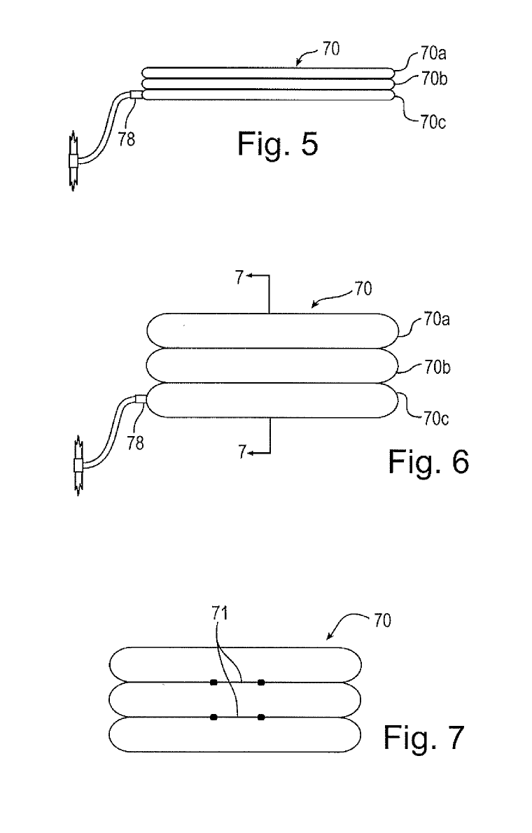

Turning to FIGS. 5 through 7, lifting element 10 incorporates an inflatable bladder assembly 70 to selectively elevate and lower the platform. Bladder assembly70 consists of multiple bladder sacs 70a, 70b and 70c in overlying (stacked) relationship. The multiple sacs 70a-c are fastened together, and are in internal communication with each other via openings 71 such that air travels between the bladders for simultaneous and rapid inflation or deflation. Assembly 70 is formed from an impervious material, such as butyl rubber or coated fabric. The material should be sufficiently thin such that when deflated, the compressed bladders take up little horizontal spacing, but the material should also be sufficiently robust to essentially eliminate the risk of rupture during ordinary use. The use of a relatively thin and highly flexible material is preferred to maintain a low profile of the lifting elements when lowered, and also to permit rapid and complete lowering of lifting elements 10 even in the absence of a compressive force applied by the weight of a user. Assembly 70 substantially covers the base plate 40, in order to maximize the available lifting area and volume. An alternative to the use of multiple sacs forming assembly 70 is a single monolithic bladder sac (not shown) containing an internal web connecting the opposing upper and lower sides so as to allow elasticity in the vertical plane, but restricting expansion in the horizontal plane.

Bladder assembly 70 is selectively inflated by means of an air supply 76 which delivers a supply of compressed air at a relatively low pressure and high volume. Preferably, a single air supply 76 supplies bladders 70a-c. However, it is also contemplated that multiple air supplies may be provided, in particular when the device is configured for a lengthy or interrupted flight of stairs. The air supply may comprise either a standard air compressor fitted with a suitable air receiver and pressure regulator, or a diaphragm pump. A high pressure pump fitted with an air reservoir and regulator can, if provided with a sufficiently large reservoir, enable operation for some time following a power failure, assuming that the electrical controls of the system were backed up with battery power. An “on demand” low pressure high volume (diaphragm or similar) pump can provide quiet operation if space limitation does not permit remote placement of the air supply. Optionally, the air supply is able to also exhaust air from the bladders for rapid decompression into the lowered position. For example, in the case of a relatively large unit and/or to reduce the fall time, a low vacuum could be provided to exhaust the air more quickly. A vacuum in the system can be generated by means known per se in the art, such as being generated from the intake manifold of the compressor.

Assembly 70 is provided a valve 78 in communication with the interior of the assembly. Valve 78 is a three-way valve configured to provide an “off” position wherein air can neither exit nor enter the bladder, and “intake” and “discharge” positions permitting either a rapid intake or discharge of air so as to permit compression or inflation of the bladder. Valve 78 is electronically actuated, and is in electronic operative communication with the control unit, described below. An air supply tube, described below, feeds air into bladder 70.

As seen in FIG. 3, an accordion-type skirt 82 surrounds each lifting element, with the upper edge of the skirt being engaged to the side edges of the upper platform 20, and the lower edge of the skirt either being unattached, or preferably, attached to the side edges of the base plate 30. Skirt 82 shields the inner components of the lifting element, thereby providing a more attractive visual appearance, and also preventing contamination and damage to the internal components of the lifting element.

The lifting power required by the typical system should be sufficient to lift a full size adult. In one non-limiting example, the lifting power is about 250 pounds (113 kg). More powerful and robust systems may be provided for larger individuals. Since the lifting area is approximately 1 square foot (0.09 m²), or greater, the air pressure required to lift a 250 pound (113 kg) user would be in the order of 2.5 psi (17.2 KPa) or less. The preferred air supply is capable of providing a relatively large volume of air, at a relatively low pressure in order to rapidly elevate the lifting elements.

The system is controlled in part by at least one user interface 90, shown schematically in FIG. 4, which can be mounted to a wall or other surface adjacent to the staircase, or positioned in an otherwise accessible location. Preferably, two user interfaces are provided at the lower and upper ends of the staircase respectively. If the staircase comprises multiple flights interrupted by platforms, a plurality of user interfaces may be provided at the upper and lower ends of each flight. User interface 90 permits the user to control the system in various modes of operation, as will be described below.

The air supply pump 76 is housed together with a control unit 100 which controls the operation of the system. Preferably, control unit 100 comprises a solid state electronic/integrated circuit or other electronic control means, responsive to input signals from the pressure sensors 22 and user interfaces 90 in a manner per se known to the art. Control unit 100 is in operative communication with the pump 76 and valves 80 so as to control their operation in response to the respective inputs received by the control unit, and in accordance with the logic described below.

FIG. 4 is a schematic illustration of a system comprising three lifting elements 10a-c and control unit 100. The control unit 100 may be mounted or positioned in a variety of locations, such as mounted on a convenient wall surface adjacent to the staircase or positioned on the floor adjacent the staircase, and linked to a separate user interface connected by wire or wirelessly to the pump/controller unit. Communication links 102, preferably wires, transmit electronic signals from the sensor 22 associated with each lifting element 10 to the control unit 100, and to the valves 78

A trunk line air hose 106 extends from the pump 76, with individually controlled branch hoses 110 feeding the individual bladders 70. Branch hoses 110 each lead from a three-way connector 112 that join the respective branches 110 to the trunk 106.

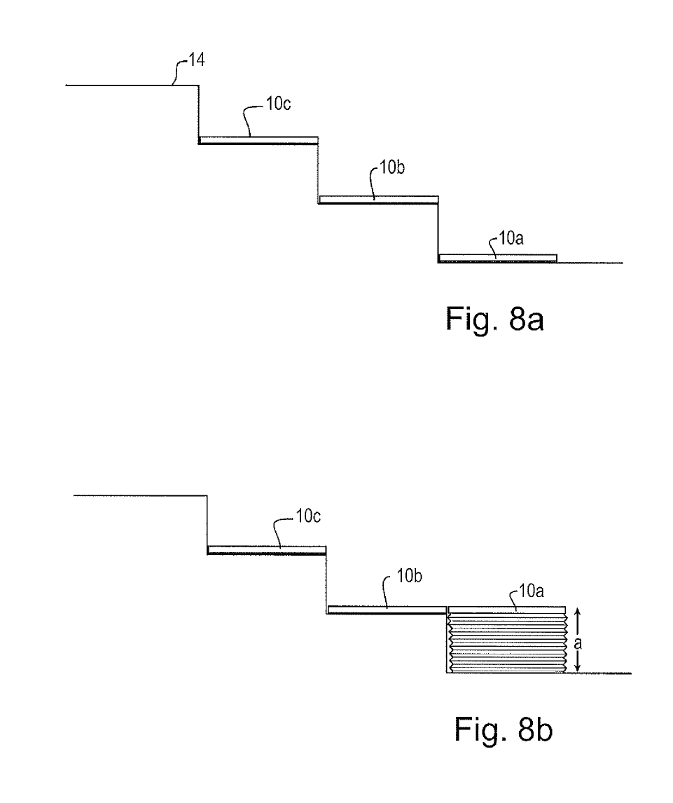

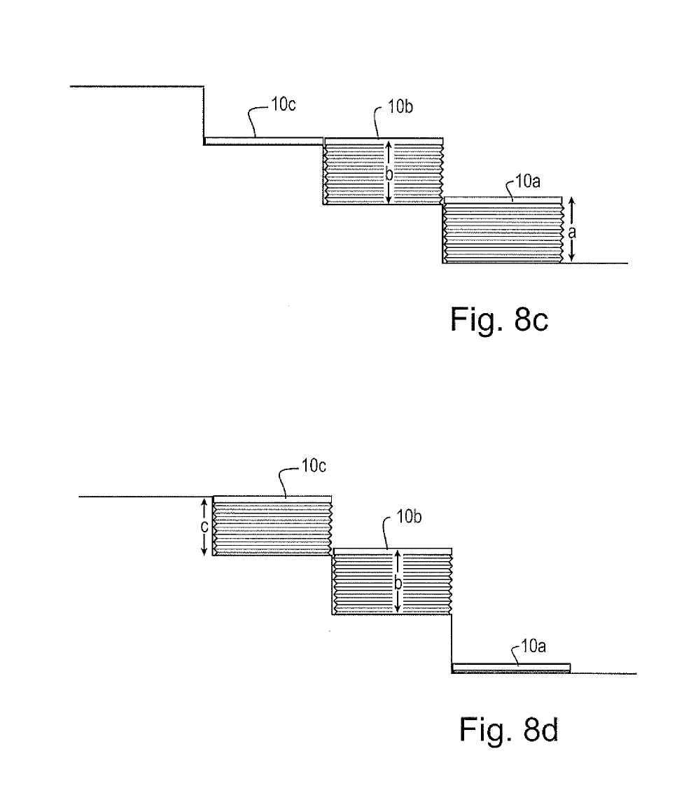

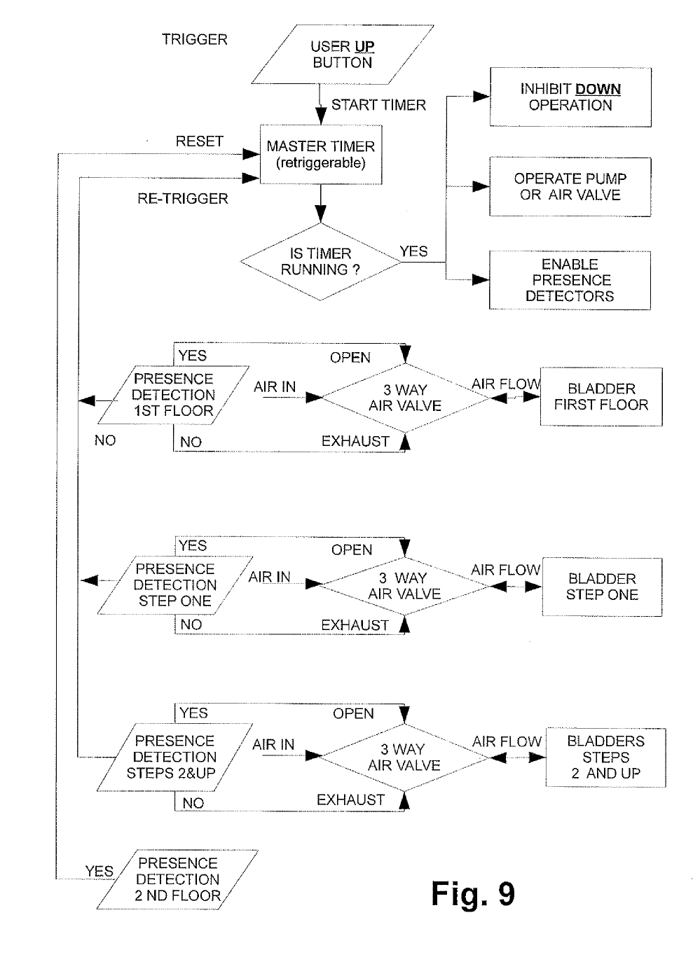

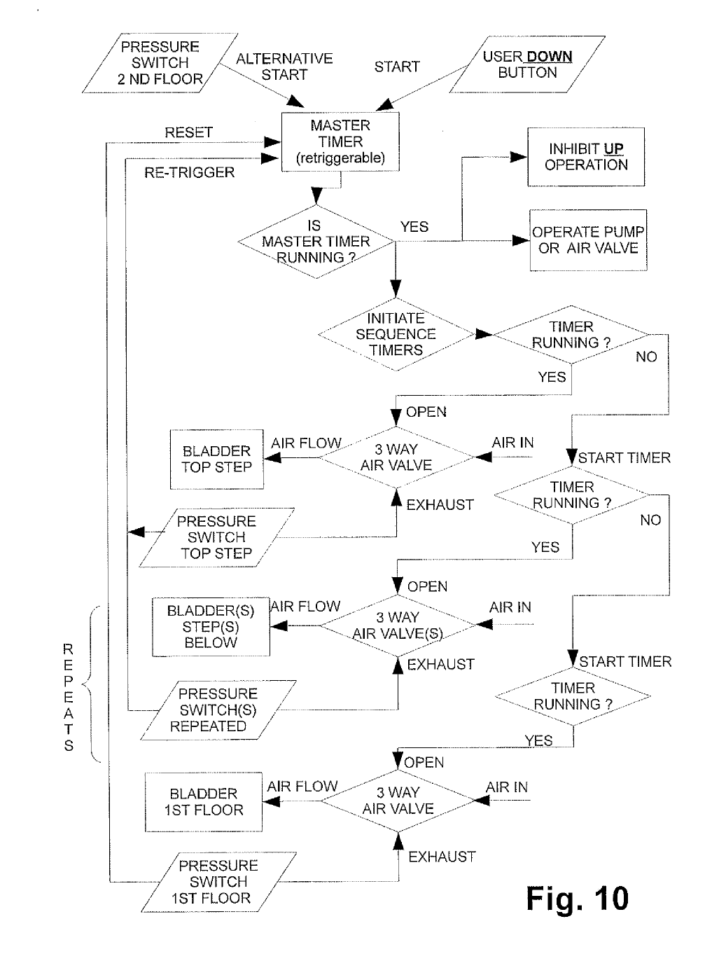

Operation of the system is illustrated in part by the sequence of operation shown in FIGS. 8a to 8d, and the flow charts shown in FIGS. 9 and 10. FIGS. 8a to 8d show schematically a series of lifting elements 10 installed on a staircase 14. FIGS. 9 and 10 show operation of the control system 100 in response to actuation by the user interface. FIG. 9 shows operation of the system in the “up” mode wherein a user at the base of the staircase actuates the system for travel up the staircase, and FIG. 10 shows the reverse, namely operation of the system in the “down” mode, wherein the user at the top of the staircase activates the system for travel down the staircase.

The user interface 90 permits the user to operate the system in the following modes:

1) An “off” mode, wherein the pump 76 is fully off. All lifting elements 10 are in the lowered position, as seen in FIG. 8a. The valves 80 of the bladders 70 are all closed. If the user selects the “off” position, the staircase may be utilized as a conventional staircase.

2) an “up” mode, intended to assist a user to ascend the stairs. In this mode, the pump is running and the system is responsive to user actuation. The valves 80 remain closed. The lifting elements remain in their lowered position until the lifting sequence is triggered by the user standing upon the lowermost lifting element, as described below. This mode is effectively the “standby” mode of the system.

3) a “down” mode, intended to assist a user to descend the stairs. In this mode, the lifting elements are all in their fully elevated positions to await a user stepping on the uppermost platform.

If the system is “off”, a user who approaches the staircase from its lower end commences operation of the system by actuating the user interface 90 to signal that the system is to be used in an “up” mode of operation.

Other control modes are contemplated. For instance, a READY (or AUTO) mode in which the unit is always on standby and automatically switches to the UP or DOWN modes of operation when a user places two feet side by side on the bottom or top platform, respectively. The user's feet must be placed over both pressure sensors in order to activate the system. The controller senses the presence of the user on the uppermost or lowermost platform, and activates the system in the down or up mode, as required. In this mode, a non-disabled person would not normally activate the system, since such a person would normally only place a single foot on any given tread, thereby allowing him to walk up or down the staircase in a normal fashion. In order to configure the system in this mode, the uppermost and lowermost platforms may be provided with two spaced apart pressure sensors located to detect a user standing thereon with both feet in a normal standing position. Preferably, the intermediate lifting platforms are likewise provided with spaced apart pressure sensors.

The user interface 90 includes a switch 114 to control the system operation. Switch 114 may consist of a single multi-way switch, or separate 2-way switches.

The speed by which platform 20 is elevated may be may be fixed at a single speed or variable. Persons skilled in the art, or the user, will readily determine a suitable speed that is sufficiently rapid, while not being too fast so as to upset the user's balance. Optionally, the system may be configured to provide a short acceleration and deceleration, so as not to start and stop too abruptly.

The sequence of operation in the “up” mode is summarized as follows:

a) Commencing with the fully lowered position of FIG. 8a, the system is actuated by a user stepping upon the platform of the lowermost, first-in-line lifting element 10a. The presence of a person standing on element 10a is detected by pressure sensor 22. Control unit 100 activates pump 76 and valve 78a to inflate bladder 70a.

b) Lifting element 10a is raised to its maximally elevated position wherein its platform is level with the platform 20 of second-in-line lifting element 10b (distance “a”), as seen in FIG. 8b.

c) The user steps onto the second lifting element 10b. Since this is now level with the first lifting element 10a, the user need only step forwardly.

d) The pressure sensor of the second lifting element 10b detects the presence of the user standing thereon (with both feet standing on the platform), triggering the expansion of element 10b to the height of the next-in-line lifting element 10c (distance “b”), as seen in FIG. 8c.

e) As seen in FIG. 8d, the above sequence repeats for lifting element 10c, which elevates distance “c” to be level with the floor at the top of the staircase. At the same time or shortly after element 10c is actuated, lifting element 10a is deflated and permitted to lower, to await a subsequent user.

f) For a longer flight of stairs than illustrated herein, above steps c and d repeat themselves for subsequent lifting elements until the user has reached the top of the staircase. After each step, the lifting element which is two steps below the user is lowered. This delay provides at least two steps at all times between the user and any double-height drop between stairs.

g) Once the user has stepped off the system, the lifting elements all return to their lowered position, and the system reverts to the up/standby mode to await the next user.

Operation of the system in the “down” mode is similar to the above. A user at the top of the staircase will initially switch the system into its down mode with user interface 90. All of the lifting elements will then be elevated to their uppermost positions to await the user. The elevation of all units may either occur simultaneously, or in a rippling (sequential) fashion beginning with the uppermost steps (closest to the user). The sequence of operation for descending is then essentially the reverse of steps a-g described above. In contrast with the up mode, after the user steps off of a platform, there is no delayed reversion of the lifting elements to their preceding state, in that each can remain in its lowered position after use.

Optionally, the system may be configured to always revert to the standby/up mode after each use. The lower user interface may then be eliminated, as it would be redundant.

It will be seen that the uppermost element 10c must have a lesser maximal elevation, since it is only required to raise the platform to be level with the uppermost floor, rather than being level with a next-in-line lifting element. Thus, the top to bottom distance “c” of uppermost element 10c when in the fully raised position is somewhat less the top to bottom distances “a” and “b” of lower and intermediate elements 10a and 10b, by an amount equal to the thickness of fully depressed element 10.

Persons skilled in the art will recognize that modifications may be made to the embodiment described above. For example, the pneumatic fluid fed to the bladders 70, while normally comprising ordinary air, may comprise a different gas and even, potentially a liquid, for certain applications. As well, a lifting device which employs the same or similar inventive concept may be provided which comprises only a single lifting element, for example for use for elevating a child or other short person at a sink, countertop or other location. In this version, the pressure-sensitive means is optional, as the unit may be controlled solely by the user interface. As well, the system can be adapted with larger platforms, for use by an individual in a wheelchair, particularly if the device is not restricted to the configuration of a stair tread.

Although the invention has been described by way of certain embodiments thereof, it will be seen that the present invention is not limited in its scope to particulars and details of the embodiments described herein. Rather, the full scope of the invention encompasses numerous departures from, variations to, and functional and mechanical equivalents of elements described herein. Rather, the full scope of the present invention may be derived from the present patent specification as a whole, including the claims, drawings and other elements thereof.

1. An elevating system for a staircase, comprising a plurality of lifting elements configured to each cover a staircase tread, said lifting elements capable of vertical expansion and contraction between a lowered position and an elevated position so as to elevate or lower a user standing upon said lifting element, each of said lifting elements comprising a platform to support the user, at least one inflatable bladder positioned beneath said platform and bearing directly or indirectly upon said platform to elevate said platform when inflated, a guide configured to restrict lateral movement of said platform, a sensor responsive to the presence of an individual on said platform, an air supply for inflation of said bladders, and a controller in communication with said sensors and air supply to operate said system wherein said platforms may be sequentially elevated or lowered by inflating or deflating said bladders in response to the presence of said user on said platforms to permit the user to travel up or down said staircase by stepping horizontally from one of said lifting elements to a next-in-line of said lifting elements.

2. A system as defined in claim 1 further comprising at least one valve in operative communication with and responsive to said controller for selective inflation or deflation of said bladders.

3. A system as defined in claim 1 wherein said bladder comprises a plurality of internally communicating bladder sacs in overlying relationship.

4. A system as defined in claim 1 wherein said guide comprises at least two pantograph assemblies configured at perpendicular relationship to each other.

5. A system as defined in claim 1 further comprising a base plate opposed to said platform, said bladder being positioned between said base plate and said platform to bear against the underside of said platform, said guide being engaged to said base plate and said platform to confine said platform to vertical movement directly above said base plate.

6. A system as defined in claim 4 further comprising a base plate, wherein said pantograph assemblies comprise pivotally joined pantograph arms and upper and lower pantograph guides for slideably engaging said arms to said platform and base plate, said upper and lower guides being displaced from each other on opposing sides of said arms to provide a low profile to said lifting element when in the lowered position.

7. A system as defined in claim 1 wherein said sensor comprises at least one pressure sensor on said platform for detecting a user standing thereon.

8. A system as defined in claim 7 comprising two of said pressure sensors disposed in a spaced-apart configuration to detect the feet of a user standing with both feet upon said platform.

9. A system as defined in claim 1 further comprising at least one user interface in communication with said controller, adapted to permit user control over said controller wherein said user interface permits the user to operate the system in any of the following operative modes:
a) an “ascending” mode wherein all of the platforms are initially in said lowered position, and individually and sequentially elevate upon sensing of a person upon said platform;
b) a “descending” mode wherein all platforms are initially in said elevated position, and individually and sequentially lower upon sensing of a person upon said platform; and
c) an “off” mode wherein the platforms all remain in said lowered position and are non-responsive to a person upon any of said platforms.

10-11. (canceled)

12. A system as defined in claim 1 wherein said air supply further comprises a vacuum mode for removing air from said bladders.

13. An elevating device comprising a lifting element capable of vertical expansion and contraction between a lowered position and an elevated position to elevate or lower an individual, said lifting element comprising a platform to support the user, at least one inflatable bladder positioned beneath said platform to elevate said platform when inflated, a guide configured to restrict lateral movement of said platform, an air supply for selective inflation of said bladders, said bladders being deflatable for contraction of said lifting element.

14. A device as defined in claim 13 further comprising at least one valve in communication with said bladders for selective inflation or deflation of said bladders.

15. A device as defined in claim 13 wherein said bladder comprises a plurality of internally communicating bladder sacs in overlying relationship.

16. A device as defined in claim 13 wherein said guide comprises at least two pantograph assemblies configured at perpendicular relationship to each other engaged to said platform.

17. A device as defined in claim 13 further comprising a base plate opposed to said platform, said bladder being positioned between said base plate and said platform, said guide being engaged to said base plate and said platform to confine said platform to vertical movement directly above said base plate.

18. A device as defined in claim 13 further comprising a sensor responsive to the presence of an individual on said platform and a controller, said controller being in communication with said sensors to operate said system wherein said platform may be selectively elevated or lowered in response to the presence of said user on said platform.

19. A method of conveying a person up or down a staircase, comprising the steps of:
a) providing a system as defined in claim 1;
b) lowering or raising all of said platforms to configure said system into an ascending or descending mode respectively;
c) sensing the presence of a person upon a first of said platforms located at an upper or lower end of said staircase;
d) elevating or lowering said first platform from said initially lowered or elevated position, respectively, to selectively elevate or lower said person wherein said platform is level with a next in line of said platforms;
e) sequentially repeating steps (c) and (d) for the length of said staircase; and
(f) optionally returning all of said platforms to a selected elevated or lowered position.

20. A method as defined in claim 19 wherein said system comprises the following user-selectable modes of operation: 1) an “off” mode, wherein the staircase may be utilized as a conventional staircase; 2) an “up” mode, to convey a user up the stairs; and 3) a “down” mode, to convey a user down the stairs, wherein the lifting elements are all initially in their fully elevated position.

21. A method as defined in claim 20 further comprising providing a “ready” mode wherein said system remains in said up mode, and said system is configured to respond to the presence of a user on the uppermost or lowermost of said lifting elements following selection of said up or down setting.

22. A method as defined in claim 21 wherein the sensors on at least the uppermost and lowermost lifting elements comprise two spaced apart pressure sensors configured to detect a user's two feet thereon, and said system is configured to respond only when both of said pressure sensors are actuated by a user standing with both feet upon said uppermost or lowermost lifting element.

23. A method as defined in claim 19 wherein when conveying a person up a staircase, a first-in-line of said platforms remains in said elevated position after said user has stepped off of said platform, until at least a second-in-line adjacent platform is fully elevated.

24. (canceled)
